(19) United States
(12) Patent Application Publication
(10) Pub. No.: US 2010/0112514 A1
(43) Pub. Date: May 6, 2010

(54) WIRELESS DENTAL HANDPIECE

(76) Inventor: Chun-Leon Chen, Changhua City (TW)

Correspondence Address: Guice Patents PLLC, 12647 Galveston Court #302, Manassas, VA, 20112, US

(21) Appl. No.: 12/265,877

(22) Filed: Nov. 6, 2008

(51) Int. Cl. A61C 3/00

(52) U.S. Cl. 433/114

(57) ABSTRACT

A wireless dental handpiece includes a handpiece body that houses a rechargeable battery and a charging loop, and a charging socket that provides a power supply to the charging loop to charge the rechargeable battery upon insertion of the rear end of the handpiece body into the charging socket so that the dentist can use the dental handpiece conveniently, avoiding cable tangling.

### BACKGROUND OF THE INVENTION

1. Field of the Invention

The present invention relates to a dental handpiece and more particularly to a wireless dental handpiece that is convenient for use and avoids power cable tangling during a dental treatment.

2. Description of the Related Art

A dental handpiece is a requisite instrument during the treatment of teeth inside a patient's mouth. Basically, a dental handpiece uses a power-driven high-speed rotating mechanism to drive a pin or drill in a bearing at the front end of the handpiece body, thereby performing a dental treatment or operation.

To provide the high-speed rotating mechanism with the necessary working voltage, a dental handpiece has a power cable for connection to a power supply outlet. This power cable may be stretched accidentally, causing biasing of the handpiece body. Further, the power cable imparts a pressure to the handpiece body, hindering adjustment of the angle of the handpiece body by the dentist.

Therefore, it is desirable to provide a dental handpiece that eliminates the aforesaid problems.

### SUMMARY OF THE INVENTION

The present invention has been accomplished under the circumstances in view. It is therefore the main object of the present invention to provide a wireless dental handpiece, which facilitates operation and avoids cable tangling during operation.

To achieve this and other objects of the present invention, the wireless dental handpiece is comprised of a handpiece body and a charging socket. The handpiece body has installed therein a rechargeable battery, a charging loop, and a conducting terminal. The charging socket has a contact terminal. When inserted the handpiece body into the charging socket to force the conducting terminal into contact with the contact terminal, the charging loop charges the rechargeable battery with a power supply from the charging socket to the saturated status. Thus, the wireless dental handpiece needs not to connect with a power cable, avoiding cable tangling during operation.

Further, the charging socket can be installed in the bracket table arm of a dental unit near the instrument tray so that the dentist can insert the handpiece body into the charging socket conveniently to have the rechargeable battery to be charged to the saturated status when battery power low.

### BRIEF DESCRIPTION OF THE DRAWINGS

FIG. 1 is an exploded plain view of a wireless dental handpiece in accordance with the present invention.

FIG. 2 is a plain assembly view of the wireless dental handpiece in accordance with the present invention.

FIG. 3 is a schematic drawing of the present invention, showing the charging socket of the wireless dental handpiece installed in a bracket table arm of a dental unit.

### DETAILED DESCRIPTION OF THE PREFERRED EMBODIMENT

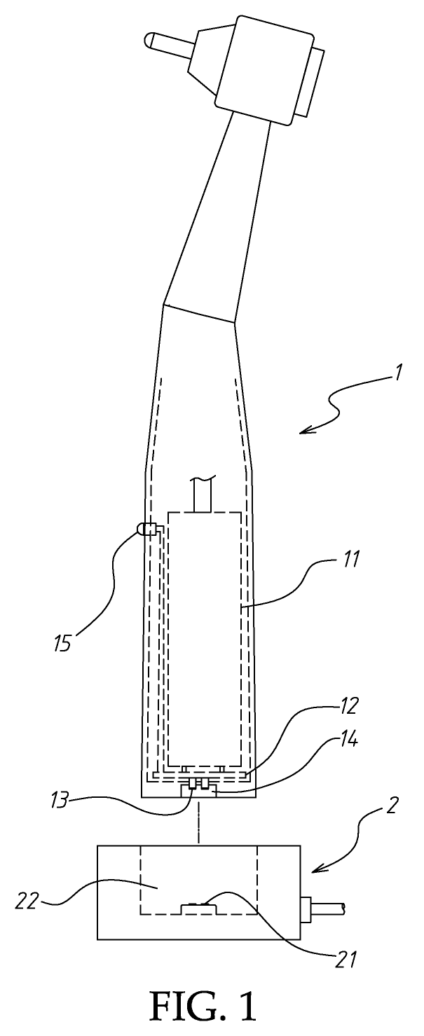

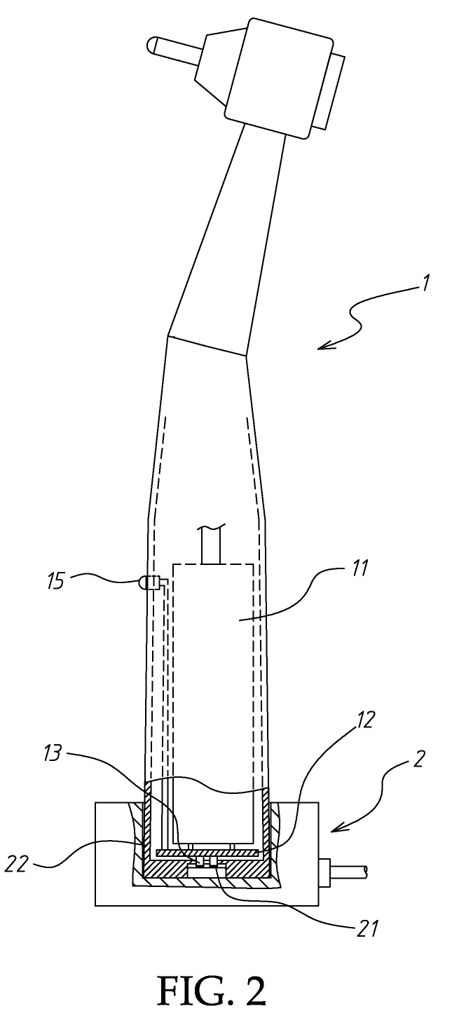

Referring to FIGS. 1 and 2, a wireless dental handpiece in accordance with the present invention is shown comprising a handpiece body 1 and a charging socket 2.

The handpiece body 1 has installed therein a rechargeable battery 11, a charging loop 12, and a conducting terminal 13. The conducting terminal 13 is installed in a plug hole 14 on the rear end of the handpiece body 1, and electrically connected to the rechargeable battery 11 through the charging loop 12. The handpiece body 1 further houses a high-speed rotating mechanism (not shown). The rechargeable battery 11 provides the high-speed rotating mechanism with the necessary working voltage. The charging socket 2 has a socket hole 22 adapted to accommodate the handpiece body 1, and an electric terminal 21 installed in the socket hole 22 for the contact of the conducting terminal 13.

Referring to FIG. 2, when inserted the rear end of the handpiece body 1 into the socket hole 22 of the charging socket 2, the contact terminal 21 is inserted into the plug hole 14 to contact the conducting terminal 13, causing the charging loop 12 to charge the rechargeable battery 11 to the saturated status for normal operation. Further, the handpiece body 1 is provided with an indicator light 15 electrically connected to the charging loop 12 for charging saturation indication.

By means of the application of the present invention, the wireless dental handpiece needs not to connect with a power cable, avoiding cable tangling during the treatment of teeth inside a patient's mouth.

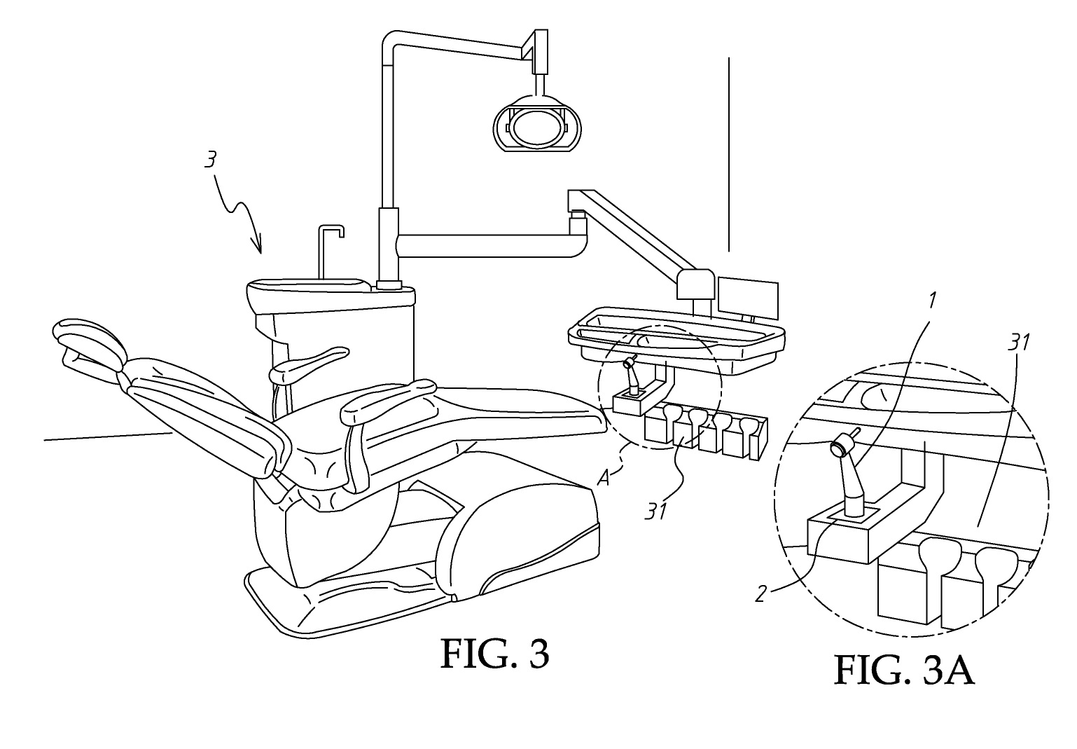

Referring to FIGS. 3 and 3A, the charging socket 2 is installed in a part of the bracket table arm of a dental unit 3 near the instrument tray 31. The handpiece body 1 can be inserted into the charging socket 2 to have the rechargeable battery 11 be charged to the saturated status when the power of the rechargeable battery 11 is low.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A wireless dental handpiece comprising
a handpiece body, said handpiece body comprising a rechargeable battery to provide a high-speed rotating mechanism in said handpiece body with the necessary working voltage, a charging loop for charging said rechargeable battery with an external power supply, and a conducting terminal mounted in a rear end of said handpiece body and electrically connected to said charging loop for transmitting an external power supply to said charging loop to charge said rechargeable battery; and
a charging socket for providing a power supply to said charging loop through said conducting terminal, said charging socket comprising a contact terminal for the contact of said conducting terminal to provide a power supply to said charging loop.

2. The wireless dental handpiece as claimed in claim 1, wherein said handpiece body comprises an indicator light electrically connected to said charging loop for charging saturation indication.

3. The wireless dental handpiece as claimed in claim 1, wherein said charging socket comprises a socket hole for the insertion of the rear end of said handpiece body; said contact terminal is installed in said socket hole.

4. The wireless dental handpiece as claimed in claim 1, wherein said charging socket is installed in a part of a bracket table arm of a dental unit near an instrument tray.
